(19) United States
(12) Patent Application Publication
(10) Pub. No.: US 2024/0054557 A1
(43) Pub. Date: Feb. 15, 2024

(54) ACTIONABLE ALERT AT NEGATIVE MODIFICATION EVENT

(71) Applicant: The Toronto-Dominion Bank, Toronto (CA)

(72) Inventors: Milos DUNJIC, Oakville (CA); David Samuel TAX, Toronto (CA); Kushank RASTOGI, Toronto (CA)

(21) Appl. No.: 17/887,820

(22) Filed: Aug. 15, 2022

(51) Int. Cl. G06Q 40/02; G06Q 20/40; G06Q 20/22

(52) U.S. Cl. CPC G06Q 40/02; G06Q 20/403; G06Q 20/227

(57) ABSTRACT

In some aspects, a computing system may include a processor. Also, the computing system may include a communications module coupled to the processor. Furthermore, the computing system may include a memory coupled to the processor, the memory storing instructions that, when executed, configure the computing system to: determine a daily positive modifier amount based on an amount of positive adjustments to an account over an extended time period; determine a daily non-discretionary negative modifier amount based on an amount of non-discretionary negative adjustments to the account over the extended time period; determine a daily discretionary amount based on the daily positive modifier amount and the daily non-discretionary negative modifier amount; detect an expected negative modification event; and in response to detect the expected negative modification event, trigger a notification based on the daily discretionary amount.

### TECHNICAL FIELD

The present application relates to actionable alerts and, more particularly, to the triggering of actionable alert based on a daily discretionary amount at a negative modification event.

### BACKGROUND

Computer-based resource management systems may be used for managing various resources including, for example, processing resources, memory resources, cryptocurrency, and other stored value. Some such resource management systems periodically review aggregate resource over a period of time or peak resource demand or other metrics. For example, some systems may periodically generate reports highlighting resource usage or they may generate alerts upon determining that all resources have been used.

Periodic review of resource usage or alerts due to resource exhaustion allows only for reactionary resource management. Thus, there is a need for improved resource monitoring systems.

### BRIEF DESCRIPTION OF THE DRAWINGS

FIG. 1 is a schematic operation diagram illustrating an operating environment of an example embodiment;

FIG. 2 is a simplified schematic diagram showing components of a computing device;

FIG. 3 is a high-level schematic diagram of an example computer device;

FIG. 4 shows a simplified organization of software components stored in a memory of the example computer device of FIG. 3;

FIG. 5 is a flowchart of an example method of triggering a notification based on a daily discretionary amount in accordance with example embodiments of the present disclosure;

FIG. 6 is an example interface in accordance with an example embodiment of the present disclosure;

FIG. 7 is a flowchart of an example method of initiating a transfer in accordance with example embodiments of the present disclosure;

FIG. 8 is a graphical representation indicating recent daily discretionary modifications in accordance with an example embodiment of the present disclosure; and

FIG. 9 is a graphical representation indicating daily resource accumulation in accordance with an example embodiment of the present disclosure.

### DETAILED DESCRIPTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, a method may include determining a daily positive modifier amount based on an amount of positive adjustments to an account over an extended time period. The method may also include determining a daily non-discretionary negative modifier amount based on an amount of non-discretionary negative adjustments to the account over the extended time period. The method may furthermore include determining a daily discretionary amount based on the daily positive modifier amount and the daily non-discretionary negative modifier amount. The method may in addition include detecting an expected negative modification event. The method may also include, in response to detecting the expected negative modification event, triggering a notification based on the daily discretionary amount. Other embodiments of this aspect include corresponding computer systems, apparatus, and computer programs recorded on one or more computer storage devices, each configured to perform the actions of the methods.

Implementations may include one or more of the following features. Methods where the expected negative modification event is detected based on a location associated with a client device on which the notification is triggered. Methods where the expected negative modification event is detected by determining that the client device is within a particular geofence. Methods where the particular geofence is a geofence associated with discretionary modifications. Methods where detecting the expected negative modification event includes detecting the initiation of a transfer. Methods where the transfer is initiated at a point-of-sale terminal. Methods where the notification includes a selectable option to utilize an alternate resource for the expected negative modification event. Methods may include: receiving an indication of a selection of the selectable option; in response to receiving the indication of the selection of the selectable option, processing a transfer using the alternate resource to avoid a negative modification event at the account. Methods may include: determining that a particular negative adjustment to the account is periodic; and in response to determining that the particular negative adjustment to the account is periodic, categorizing the particular negative adjustment as a non-discretionary negative adjustment. Methods where the daily discretionary amount is determined without reference to any past adjustments categorized as discretionary adjustments. Methods may include, prior to triggering the notification, determining that the expected negative modification event is discretionary and where the notification may be triggered responsive to determining that the modification event is discretionary. Methods where the notification indicates a portion of the daily discretionary amount remaining for a current day. Methods may include: determining that an amount of the expected negative modification event exceeds the portion of the daily discretionary amount remaining for the current day, and where the notification is triggered responsive to determining that the amount of the expected negative modification event exceeds the portion of the daily discretionary amount remaining for the current day. Methods where the notification includes a graphical representation indicating recent daily discretionary modifications relative to the daily discretionary amount. Implementations of the described techniques may include hardware, a method or process, or a computer tangible medium.

In one general aspect, a computing system may include a processor. The computing system may also include a communications module coupled to the processor. The computing system may furthermore include a memory coupled to the processor, the memory storing instructions that, when executed, configure the computing system to: determine a daily positive modifier amount based on an amount of positive adjustments to an account over an extended time period; determine a daily non-discretionary negative modifier amount based on an amount of non-discretionary negative adjustments to the account over the extended time period; determine a daily discretionary amount based on the daily positive modifier amount and the daily non-discretionary negative modifier amount; detect an expected negative modification event; and in response to detect the expected negative modification event, trigger a notification based on the daily discretionary amount.

Implementations may include one or more of the following features. Computing systems where the expected negative modification event is detected based on a location associated with a client device on which the notification is triggered. Computing systems where the expected negative modification event is detected by determining that the client device is within a particular geofence. Computing systems where the particular geofence is a geofence associated with discretionary modifications. Computing systems where detecting the expected negative modification event includes detecting the initiation of a transfer. Computing systems where the transfer is initiated at a point-of-sale terminal. Computing systems where the notification includes a selectable option to utilize an alternate resource for the expected negative modification event. Computing systems where the instructions further configure the computing system to: receive an indication of a selection of the selectable option in response to receiving the indication of the selection of the selectable option, process a transfer using the alternate resource to avoid a negative modification event at the account. Computing systems where the instructions further configure the computing system to: determine that a particular negative adjustment to the account is periodic; and in response to determining that the particular negative adjustment to the account is periodic, categorize the particular negative adjustment as a non-discretionary negative adjustment. Computing systems where the daily discretionary amount is determined without reference to any past adjustments categorized as discretionary adjustments. Computing systems where the instructions further configure the computing system to: prior to triggering the notification, determine that the expected negative modification event is discretionary and where the notification is triggered responsive to determining that the modification event is discretionary. Computing systems where the notification indicates a portion of the daily discretionary amount remaining for a current day. Computing systems where the instructions further configure the computing system to: determine that an amount of the expected negative modification event exceeds the portion of the daily discretionary amount remaining for the current day, and where the notification is triggered responsive to determining that the amount of the expected negative modification event exceeds the portion of the daily discretionary amount remaining for the current day. Computing systems where the notification includes a graphical representation indicating recent daily discretionary modifications relative to the daily discretionary amount. Implementations of the described techniques may include hardware, a method or process, or a computer tangible medium.

In one general aspect, a non-transitory computer-readable medium may include one or more instructions that, when executed by one or more processors of a device, cause the device to perform a method described herein. For example, the instructions may cause a processor to: determine a daily positive modifier amount based on an amount of positive adjustments to an account over an extended time period; determine a daily non-discretionary negative modifier amount based on an amount of non-discretionary negative adjustments to the account over the extended time period; determine a daily discretionary amount based on the daily positive modifier amount and the daily non-discretionary negative modifier amount; detect an expected negative modification event; and in response to detect the expected negative modification event, trigger a notification based on the daily discretionary amount.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

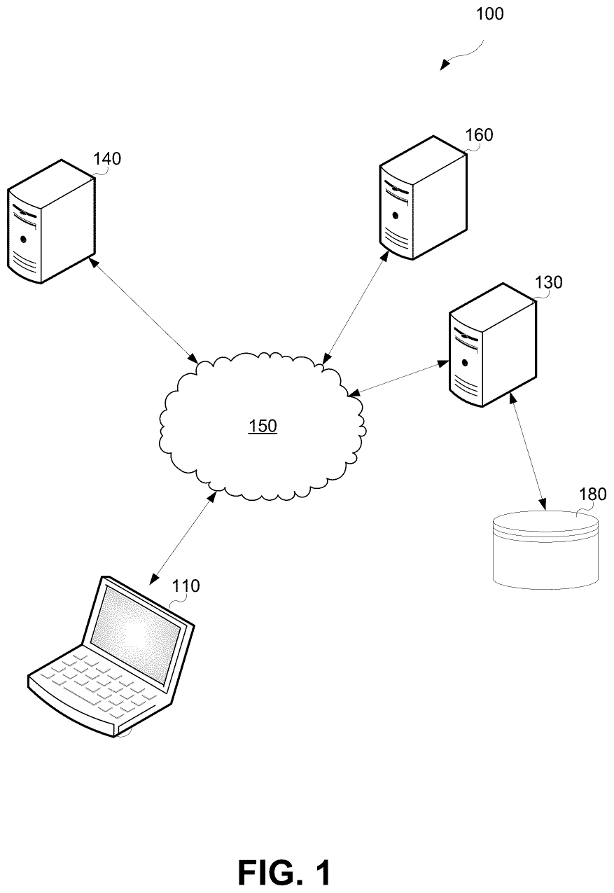

FIG. 1 is a block diagram illustrating an operating environment of an example embodiment. Various components cooperate to provide a system 100 which may be used, for example, to perform an operation. As shown, the system 100 includes a client device 110, a first server 130 and a second server 140 coupled to one another through a network 150, which may include a public network such as the Internet and/or a private network. The client device 110 is a computing device that may be associated with an entity, such as a user or client, having a record in a database associated with and/or provided by the first server 130. The record may be or represent account data. The client device 110 may also be referred to as an electronic device. The record may include data of various types and the nature of the data will depend on the nature of the first server 130.

By way of example, in some implementations, the first server 130 may maintain user accounts and a record in the database may be or represent an account. The record may include, for example, documents and/or other data stored by or on behalf of a user. By way of example, in an implementation, a user account may include documents or data uploaded by the user. Such documents and/or data may include, for example, any one or more of: images such as photographs, text-based documents, documents prepared according to a standardized file format, such as portable document format (PDF) documents, user preferences, digital identity data such as stored identity information or documentation, or other types of documents and/or data. For example, in an implementation, the first server may track, manage, maintain, and/or provide resources to the entity. The resources may, for example, be computing resources, such as memory or processor cycles. By way of further example, the resources may include stored value, such as fiat currency, which may be represented in a database. For example, the first server 130 may be coupled to a database 180, which may be provided in secure storage. The secure storage may be provided internally within the first server 130 or externally. The secure storage may, for example, be provided remotely from the first server 130. For example, the secure storage may include one or more data centers. The data centers may, for example, store data with bank-grade security.

The database 180 may include records associated with a plurality of entities. For example, the records may be for a plurality of accounts and at least some of the records may define or store resources. For example, the records may define a quantity of resources. For example, the entity that is associated with the client device 110 may be associated with an account having one or more records in the database. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual bank accounts. For example, an entity may be associated with one or more bank accounts. At least some of the resources may be borrowed resources. The borrowed resources may, for example, represent an amount of credit that is available to the entity. The entity that is associated with the client device 110 and the account may be a customer of a financial institution which operates or manages the first server 130.

The first server 130 and the second server 140 may be operated by different entities. That is, the first server 130 may be associated with a first system operator and the second server 140 may be associated with a second system operator who is different than the first system operator. The second server 140 may be, for example, associated with a financial institution server that is associated with a different financial institution than a first server 130 and may maintain customer financial accounts. That is, the second server 140 may maintain a database that includes various data records. A data record may, for example, reflect an amount of value stored in a particular account associated with a user.

While not illustrated in FIG. 1, the second server 140 may include or be connected with a database that operates similar to the database 180 that provided by or associated with the first server 130.

The first server 130 and second server 140 may store other data instead of or in addition to financial account data. By way of example, as noted above, in some implementations, the first server 130 and the second server 140 may manage computing resources such as memory and/or processor cycles which may be used by the client device 110. The records may, for example, associate a particular entity with particular computer resources.

For example, the records may entitle a particular entity to exclusive or shared use of a computing resource. The servers 130, 140 may communicate with one another in order to transfer a token that allows use of a computing resource from a record maintained by the first server 130 to a record maintained by the second server 140.

In another example, the servers 130 may act as cloud-based storage and may store files, such as documents for various entities. A first server 130 may, in accordance with instructions received from an entity associated with a document, transfer that document to another entity having a record at the second server 140. By way of example, the document may be a media file, such as an electronic book, video file or audio file, having digital rights management (DRM) which only permits the document to be transferred if exclusive use of the document is transferred (i.e., if the transfer is performed such that the transferor is no longer able to use the document after the transfer). The servers 130, 140 may communicate with one another in order to transfer the document in accordance with instructions received from the client device 110.

The client device 110 may take a variety of forms such as a smartphone, a tablet computer, a wearable computer such as a head-mounted display or smartwatch, a laptop or desktop computer, or a computing device of another type. The first server 130 and/or the second server 140 may be referred to as first and second computing devices respectively and the client device 110 may be referred to as a third computing device. In certain embodiments, the client device 110 may be adapted to present a graphical user interface that allows for communication with the first server 130. For example, the second server 140 may be adapted to send a signal representing a data transfer request to the first server 130. The first server 130 may be adapted to send, to the client device 110, a notification of the data transfer request or other interfaces and notifications.

The data transfer request may be an electronic message such as a structured electronic message. The data transfer request may include particulars of the transfer that is being requested. For example, the data transfer request may include an amount, a date such as a due date, and an identifier such as a recipient identifier. Such data may be organized in a structured format. For example, the message may include delimited data such as comma or semicolon delimited data. A delimiter may separate one field from another. The structured format may be different in other implementations. For example, the message may be formatted using a markup language such as the Extensible Markup Language (XML). In some implementations, the data transfer request may be an ISO20022 compliant message.

The network 150 is a computer network. In some embodiments, the network 150 may be an internetwork such as may be formed of one or more interconnected computer networks. For example, the network 150 may be or may include an Ethernet network, an asynchronous transfer mode (ATM) network, a wireless network, a telecommunications network, or the like.

The first server 130 may be configured to communicate with other servers, such as the second server 140 using one or more communication protocols, which may also be referred to as transfer protocols or transfer rails. The speed of the transfer protocols supported by the servers may vary. For example, at least one transfer protocol that is supported by the first server 130 may be a real time transfer protocol and at least one transfer protocol that is supported by the first server 130 may be a non-real time transfer protocol. The non-real time transfer protocol may, in at least some implementations, take more than one hour to complete a transfer. In some implementations, the non-real time transfer protocol may take twenty-four (24) hours or more to complete the transfer.

Some servers may not support some transfer protocols. For example, a third server (not shown) may not support the real time transfer protocol while the second server 140 may support the real time transfer protocol. In another implementation, the second server 140 may not support the real time transfer protocol but the third server may support the real time transfer protocol.

The real time transfer protocol may allow a transfer to be completed in real time or near real time. For example, a transfer may be completed in twenty seconds or less in at least some implementations. In some implementations, a transfer may be completed in five (5) seconds or less.

One or more of the transfer protocols supported by the first server 130 may, in at least some implementations, operate through a third-party server 160.

In at least some embodiments, a third-party server 160 may be a transfer rail server configured to facilitate a transfer from a first data record to a second data record according to a first transfer protocol. The first data record may be a data record maintained by the first server 130 and the second data record may be a data record maintained by a server associated with a different system operator than the first server 130 (e.g., such as the second server 140). The transfer rail server may be a real-time transfer rail server and may be configured to process the transfer in real-time or near real-time. The transfer rail server may operate as an intermediary between the first server 130 and the second server 140.

While not depicted in FIG. 1, in at least some implementations, the system 100 includes a further third-party server which acts as a further transfer rail server. The further third-party server may facilitate transfers between the first server 130 and the second server 140 according to a second transfer protocol. The second transfer protocol may be a non-real time transfer protocol.

One or more of the transfer protocols may not require the use of a third-party server. For example, one or more of the transfer protocols may operate through the exchange of messages directly between the first server 130 and the second server 140. Such messages may be exchanged through the network 150.

As noted previously, in one implementation, the second server 140 may be adapted to send a signal representing a data transfer request to the first server 130. In other implementations, a data transfer request may be received in another way. For example, in one implementation, a data transfer request may be sent from a client device 110 to the first server 130. For example, the data transfer request may be sent from a client device 110 as a document, such as a PDF or other document. In at least some implementations, the client device 110 may upload the document and the first server may perform optical character recognition or another recognition technique to identify the contents of the document.

The data transfer request may define a due date for completing a transfer. The due date may be, for example, a last date at which the transfer may be initiated or it may be a last date at which the transfer may be completed. The due date may also be referred to as a transfer deadline.

The data transfer request may define a transfer subject. The transfer subject defines particular data that is requested to be transferred. The data may be or represent a resource. The resource may be a copy-protected resource. For example, the resource may be any resource that for which a computer that manages that resource is configured to prevent the duplication of the resource. That is, the computer prevents the resource from being copied but it permits the resource to be transferred such that the transferor loses access to the resource following the transfer. In some implementations, the computer may be configured with digital rights management (DRM) which enforces a copying restriction on the resource. The copying restriction may allow a transfer of the resource but may prevent a duplication of the resource. For example, the computer may permit a transfer of a resource or a part thereof from a source to a destination as long as the resource or part being transferred is removed from the source so that no duplication occurs.

The resource may be of a variety of types. By way of example, in some implementations, the resources may be or include content, such as video content, audio content, an electronic book, etc. In some implementations, the resource may represent a store of value, such as money, cryptocurrency, etc.

The resource or other data that is defined in the transfer request may be a resource or other data that is defined in the database 180. For example, the resource may be stored in association with an account in the database 180. Such an account may be referred to as a transferor account.

The client device 110, the first server 130, the second server 140 and the third-party server 160 may be in geographically disparate locations. Put differently, the client device 110, the first server 130, the second server 140, and the third-party server 160 may be remote from one another.

The first server 130 may also be referred to as a first system or a first database management system. The second server 140 may also be referred to as a second system or a second database management system.

FIG. 1 illustrates an example representation of components of the system 100. The system 100 can, however, be implemented differently than the example of FIG. 1. For example, various components that are illustrated as separate systems in FIG. 1 may be implemented on a common system. By way of further example, the functions of a single component may be divided into multiple components.

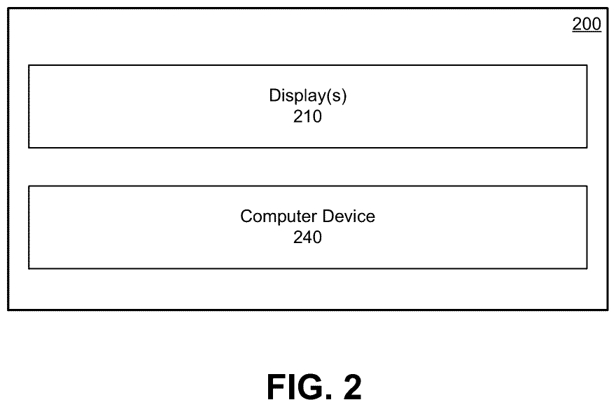

FIG. 2 is a simplified schematic diagram showing components of an exemplary computing device 200. The client device 110 may be of the same type as computing device 200. The computing device 200 may include modules including, as illustrated, for example, one or more displays 210 and a computer device 240.

The one or more displays 210 are a display module. The one or more displays 210 are used to display screens of a graphical user interface that may be used, for example, to communicate with the first server 130 (FIG. 1). The one or more displays 210 may be internal displays of the computing device 200 (e.g., disposed within a body of the computing device).

The computer device 240 is in communication with the one or more displays 210. The computer device 240 may be or may include a processor which is coupled to the one or more displays 210.

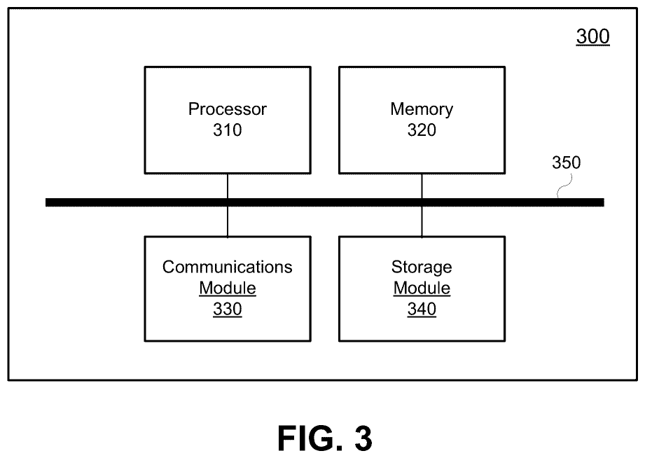

Referring now to FIG. 3, a high-level operation diagram of an example computer device 300 is shown. In some embodiments, the computer device 300 may be exemplary of the computer device 240 (FIG. 2), the first server 130, the client device 110, the second server 140 and/or the third-party server 160.

The example computer device 300 includes a variety of modules. For example, as illustrated, the example computer device 300 may include a processor 310, a memory 320, a communications module 330, and/or a storage module 340. As illustrated, the foregoing example modules of the example computer device 300 are in communication over a bus 350.

The processor 310 is a hardware processor. The processor 310 may, for example, be one or more ARM, Intel x86, PowerPC processors or the like.

The memory 320 allows data to be stored and retrieved. The memory 320 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computer device 300.

The communications module 330 allows the example computer device 300 to communicate with other computer or computing devices and/or various communications networks. For example, the communications module 330 may allow the example computer device 300 to send or receive communications signals. Communications signals may be sent or received according to one or more protocols or according to one or more standards. For example, the communications module 330 may allow the example computer device 300 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally or alternatively, the communications module 330 may allow the example computer device 300 to communicate using near-field communication (NFC), via Wi-Fi™, using Bluetooth™ or via some combination of one or more networks or protocols. In some embodiments, all or a portion of the communications module 330 may be integrated into a component of the example computer device 300. For example, the communications module may be integrated into a communications chipset. In some embodiments, the communications module 330 may be omitted such as, for example, if sending and receiving communications is not required in a particular application.

The storage module 340 allows the example computer device 300 to store and retrieve data. In some embodiments, the storage module 340 may be formed as a part of the memory 320 and/or may be used to access all or a portion of the memory 320. Additionally or alternatively, the storage module 340 may be used to store and retrieve data from persisted storage other than the persisted storage (if any) accessible via the memory 320. In some embodiments, the storage module 340 may be used to store and retrieve data in a database. A database may be stored in persisted storage. Additionally or alternatively, the storage module 340 may access data stored remotely such as, for example, as may be accessed using a local area network (LAN), wide area network (WAN), personal area network (PAN), and/or a storage area network (SAN). In some embodiments, the storage module 340 may access data stored remotely using the communications module 330. In some embodiments, the storage module 340 may be omitted and its function may be performed by the memory 320 and/or by the processor 310 in concert with the communications module 330 such as, for example, if data is stored remotely. The storage module may also be referred to as a data store.

Where the example computer device 300 functions as the first server 130 of FIG. 1, the storage module 340 may allow the example computing device 300 to access the secure data in the database 180.

Software comprising instructions is executed by the processor 310 from a computer-readable medium. For example, software may be loaded into random-access memory from persistent storage of the memory 320. Additionally or alternatively, instructions may be executed by the processor 310 directly from read-only memory of the memory 320.

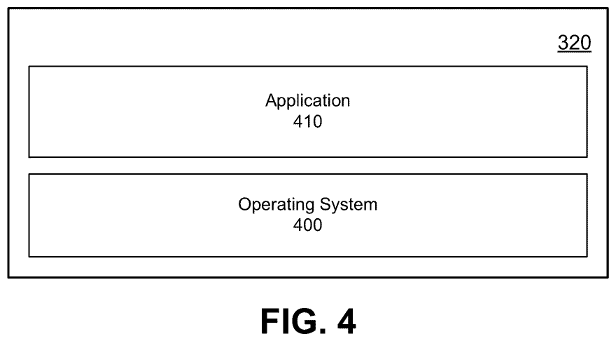

FIG. 4 depicts a simplified organization of software components stored in the memory 320 of the example computer device 300 (FIG. 3). As illustrated, these software components include an operating system 400 and an application 410.

The operating system 400 is software. The operating system 400 allows the application 410 to access the processor 310 (FIG. 3), the memory 320, and the communications module 330 of the example computer device 300 (FIG. 3). The operating system 400 may be, for example, Google™ Android™, Apple™ iOS™, UNIX™, Linux™, Microsoft™ Windows™, Apple OSX™ or the like.

The application 410 adapts the example computer device 300, in combination with the operating system 400, to operate as a device performing a particular function. For example, the application 410 may cooperate with the operating system 400 to adapt a suitable embodiment of the example computer device 300 to operate as the computer device 240 (FIG. 2), the first server 130, the client device 110, the third-party server 160 and/or the second server 140.

While a single application 410 is illustrated in FIG. 3, in operation the memory 320 may include more than one application 410 and different applications 410 may perform different operations. For example, in at least some embodiments in which the computer device 300 is functioning as the client device 110, the applications 410 may include a transfer management application. The transfer management application may be configured for secure communications with the first server 130 and may provide various functions such as, for example, the ability to display data in a record in the database 180. In some implementations, the transfer initiation application may be a banking application which may, for example, be configured to display a quantum of value in one or more data records (e.g. display balances), configure or request that operations such as transfers of value (e.g. bill payments, email money transfers and other transfers) be performed, and perform other account management functions.

By way of further example, in at least some embodiments in which the computer device 300 functions as the client device 110, the applications 410 may include a web browser, which may also be referred to as an Internet browser. In at least some such embodiments, the first server 130 may be or include a web server that may serve one or more of the interfaces described herein. The web server may cooperate with the web browser and may serve as an interface when the interface is requested through the web browser. For example, the web browser may serve as a mobile banking interface. The mobile banking interface may provide various banking functions such as, for example, the ability to display a quantum of value in one or more data records (e.g. display balances), configure or request that operations such as transfers of value (e.g. bill payments and other transfers) be performed, and other account management functions.

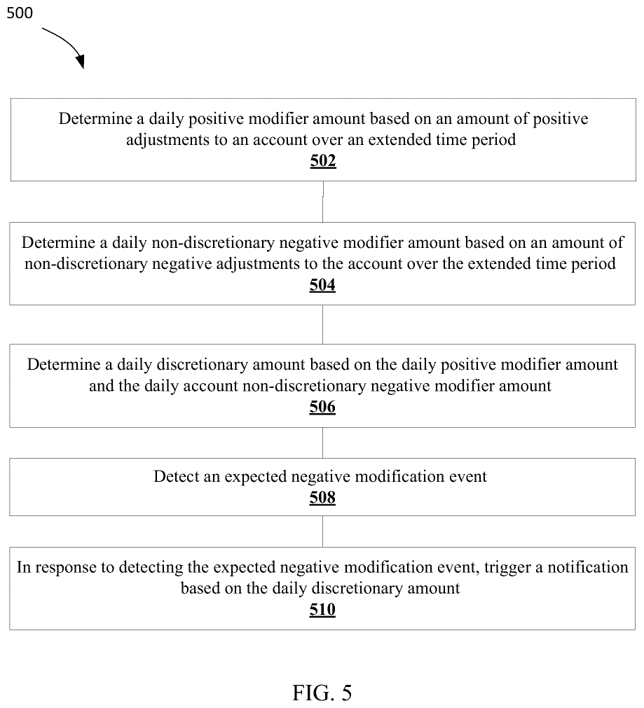

Reference will now be made to FIG. 5, which illustrates a flowchart of an example method 500. FIG. 5 shows operations performed by a computing system, such as the first server 130. For example, in at least some implementations, computer-executable instructions stored in memory associated with the computing system may configure the computing system to perform the operations of the method 500 or a portion thereof. By way of example, the computer-executable instructions may cause a processor associated with the computing system to perform the method 500 or a portion of the method 500.

The computing system performing the method 500 may cooperate with other computing systems using a communications module. The communications module may be or include a hardware communications module. In some implementations, the one or more of the other computer systems may perform one or more operations of the method 500 or may cooperate with the first server 130 in performing the method 500.

As shown in FIG. 5, a method 500 may include, at an operation 502, determining a daily positive modifier amount. The daily positive modifier amount may be determined based on an amount of positive adjustments to an account over an extended time period. The daily positive modifier amount may also be referred to as a daily resource gain parameter and it may be determined based on an amount of resource gains associated with an account over the extended time period. The daily resource gain parameter may represent a typical amount of daily resource gains and/or daily positive adjustments associated with an account. By way of example, the daily resource gain parameter may be or represent a daily increase of resources associated with an account. By way of example, the daily resource gain parameter may be or represent an average inflow to the account. The daily resource gain parameter may be determined based on the number of days represented by the extended time period. For example, the daily resource gain parameter may be determined by dividing the total resource gains and/or positive adjustments associated with the account over the extended time period by the number of days in the extended time period.

The extended time period is a time period that includes multiple days. For example, the extended time period may be a weekly, monthly or yearly time period. In some implementations, the extended time period may be a fixed number of days such as, for example, 30, 60, 90 or 120 days.

Resource gains may be or represent an amount of increases to a resource pool. By way of example, where a resource is a computing resource such as memory, a resource gain may occur when an amount of memory is increased. The increase may be due to new memory resources coming online. In some instances, new resources may become available with some regularity and so the daily resource gain parameter may reflect the frequency at which resources have become available on a per-day basis in the past. It may be noted that resources may not become available each and every day but the first server 130 may, nevertheless, determine the daily positive modifier amount.

In some implementations, resources may be or represent stored value. By way of example, the resources may be cryptocurrency or fiat currency. In at least some implementations, a resource gain or an amount of positive adjustments to an account may be or represent an increase or inflow or transfer in of stored value. By way of example, such gains and/or adjustments may be or represent income or other incoming transfers. In at least some implementations, a resource gain or an amount of positive adjustments may be or include credits to an account. The resource gains may be or include incoming payments such as payroll.

At the operation 502, the first server 130 may total up all resource gains over a time period such as a month and may divide those total resource gains by the number of days in the time period in order to determine the daily resource gain parameter.

Next, at an operation 504, the method may include determining a daily non-discretionary modifier amount. The daily non-discretionary modifier amount may also be referred to as a non-discretionary resource consumption amount or a non-discretionary resource loss parameter. The daily non-discretionary modifier amount may be an average amount of non-discretionary negative modifications that may be expected to be made to an account on any given day.

Negative modifications may be any modification or adjustment that consumes or otherwise uses resources such that resources are no longer available. By way of example, a negative modification may be or include a resource-consuming operation. Where the resources are computing resources, the negative modification may occur when computing resources are used. When the resources represent a store of value, the negative modification may include a transfer out or outflow of resources from an account; for example, a debit. A negative modification may also be referred to as a outgoing transfer in at least some implementations.

Negative modifications may be or include both discretionary and non-discretionary modifications. Discretionary negative modifications may, in at least some implementations, be considered optional modifications and non-discretionary negative modifications may be considered non-optional or mandatory modifications. A non-discretionary negative modification may represent a non-discretionary use of resources and a discretionary negative modification may represent a discretionary use of resources.

A non-discretionary negative modification may be or include a core operation that consumes resources. By way of example, in implementations in which the resources represent computing resources, a core operation may be an operating system level operation whereas a non-core operation may be an operation that is not an operating system level operation. In an implementation in which the resources represent stored value, a non-discretionary negative modification may be a modification of a particular category or type. By way of example, a non-discretionary modification may be or represent a payment related to housing, food, tax, or another non-discretionary item. Accordingly, in some implementations, non-discretionary may mean necessary and discretionary may mean not necessary.

In at least some implementations, the daily non-discretionary amount may be determined by summing up all of the non-discretionary modifications to an account over the extended time period. The total non-discretionary modifications may be averaged out over the time period. For example, the total non-discretionary modifications may be divided by the number of days in the extended time period to yield the daily non-discretionary modifier amount.

The daily positive modifier amount and the daily non-discretionary negative modifier amount may be determined from historical data such as, for example, resource usage data for the account. By way of example, the resource usage data may be or include a transaction history.

Next, at an operation 506, the method 500 may include determining a daily discretionary amount based on the daily positive modifier amount and the daily non-discretionary negative modifier amount. For example, in at least some implementations, the daily positive modifier amount and the daily non-discretionary negative modifier amount are numerical values and the daily discretionary amount may be determined as a difference between the daily positive modifier amount and the daily non-discretionary negative modifier amount. In this way, the daily positive modifier amount reflects the average daily amount of resources available for discretionary uses. Put differently, it reflects the average daily amount available for non-core uses.

The daily discretionary amount may be used for various purposes. For example, the daily discretionary amount may be used for generating alerts such as actionable alerts and other notifications.

By way of example, the first server 130 may monitor for negative modification events and may trigger a notification in response to detecting such an event. Accordingly, the method 500 may include, at an operation 510, detecting an expected negative modification event. The expected negative modification event may be an expected loss associated with an account. In some implementations, the expected negative modification event may be an event that is expected to consume resources associated with an account.

Accordingly, at an operation 508, the first server 130 may detect an expected negative modification event and, at an operation 510, the first server 130 may, in response to detecting the expected negative modification event, trigger a notification. The notification may be triggered based on the daily discretionary amount.

In some instances, the expected negative modification event may be detected based on a location associated with a client device on which the notification is triggered. For example, the client device may include a location subsystem such as a global positioning system component or a cellular triangulation component, which tracks the location of the client device. The client device may include or be associated with a software-based monitoring component which determines whether the client device is within a particular geofence. More specifically, it may determine whether the client device is within a geofence at which an account-holder is likely to use resources for discretionary purposes. The client device may generate messages or communications with the first server 130 based on the location of the client device. For example, when the client device moves within a particular geofence, an indication may be sent to the first server to inform the first server that the client device is at a location associated with discretionary modifications.

The geofences that are considered to be associated with discretionary modifications may be geofences associated with particular categories of merchants. For example, sporting goods stores, alcohol retailers, smoke shops, bookstores, dive shops and other non-essential retailers may be considered to be associated with discretionary modifications whereas grocery stores, banks, and other essential merchants and service providers may be considered to be associated with non-discretionary modifications.

Accordingly, in at least some implementations, an expected negative modification event which triggers a notification may be detected by determining that a client device is within a particular geofence. The particular geofence that triggers the notification may be one that is associated with discretionary modifications. When the client device is within a geofence that is not associated with discretionary modifications, the notification may not be triggered.

An expected negative modification event may be detected in other ways. For example, an expected negative modification event may be detected by detecting an initiation of a transfer. For example, in at least some implementations, a transfer may be initiated at a point-of-sale terminal. By way of example, the expected negative modification event may occur when an account-holder associated with an account uses a token associated with an account at a point-of-sale terminal. The token may be or include, for example, a physical token such as a payment card. The payment card may be or include a debit card or a credit card.

Although FIG. 5 shows example operations of the method 500, in some implementations, the method 500 may include additional operations, fewer operations, different operations, or differently arranged operations than those depicted in FIG. 5. Additionally, or alternatively, two or more of the operations of the method 500 may be performed in parallel.

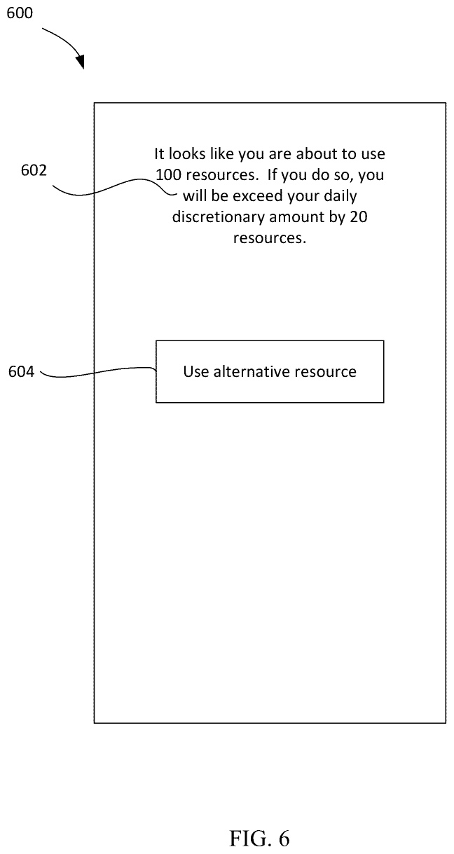

Reference is now made to FIG. 6, which illustrates an example notification 600. The notification 600 is provided in the form of an interface. The notification 600 is an actionable alert that includes both an alert 602 and a selectable option 604. The alert 602 may indicate a condition that caused the alert to be triggered. In some implementations, the alert may indicate a daily discretionary amount. For example, the alert 602 may indicate an amount of the daily discretionary amount that is remaining for a current day. Additionally or alternatively, the alert may indicate an effect of a transfer on a daily discretionary amount. For example, it may indicate an amount of the daily discretionary amount that would be remaining if a transfer or purchase were to be made.

Additionally or alternatively, the alert may indicate that there is no daily discretionary amount remaining. For example, the alert may indicate that the daily discretionary amount for a current day has already been used.

Additionally or alternatively, the alert may indicate that a particular transfer would exceed an amount of the daily discretionary amount that has not yet been used for a current date.

The notification may operate as a warning to indicate how a transfer will affect a daily discretionary amount.

The notification may include a selectable option 604. The selectable option may be a selectable option to utilize an alternative resource for the expected negative modification event. For example, the selectable option may be a selectable option to utilize a borrowed resource for the expected negative modification event and/or a selectable option to utilize a reward-based resource for the expected negative modification event, such as loyalty points. The selectable option may be activated to cause the alternative resource to be used for a transaction and/or transfer that is to be processed. The selectable option 604 may be selectable with an input interface, which may also be referred to as an input subsystem or input device associated with a device upon which the notification is displayed or otherwise output.

The example notification 600 of FIG. 6 may be displayed on a client device associated with the account for which the daily positive modifier amount was determined. The notification may be triggered within an application such as a resource management application stored on the client device. In some implementations, the notification 600 may be or include an operating system level notification. An operating system level notification is a notification that may be viewable through an operating system screen and which may be triggered even when a particular application, such as the resource management application, is not currently active.

In at least some implementations, the notification may indicate a portion of the daily discretionary amount that is remaining for a current day. That is, the notification may indicate an unused portion of the daily discretionary amount for the current day.

The notification may be of a different type apart from that displayed in FIG. 6. By way of example, the notification may be audible in at least some implementations.

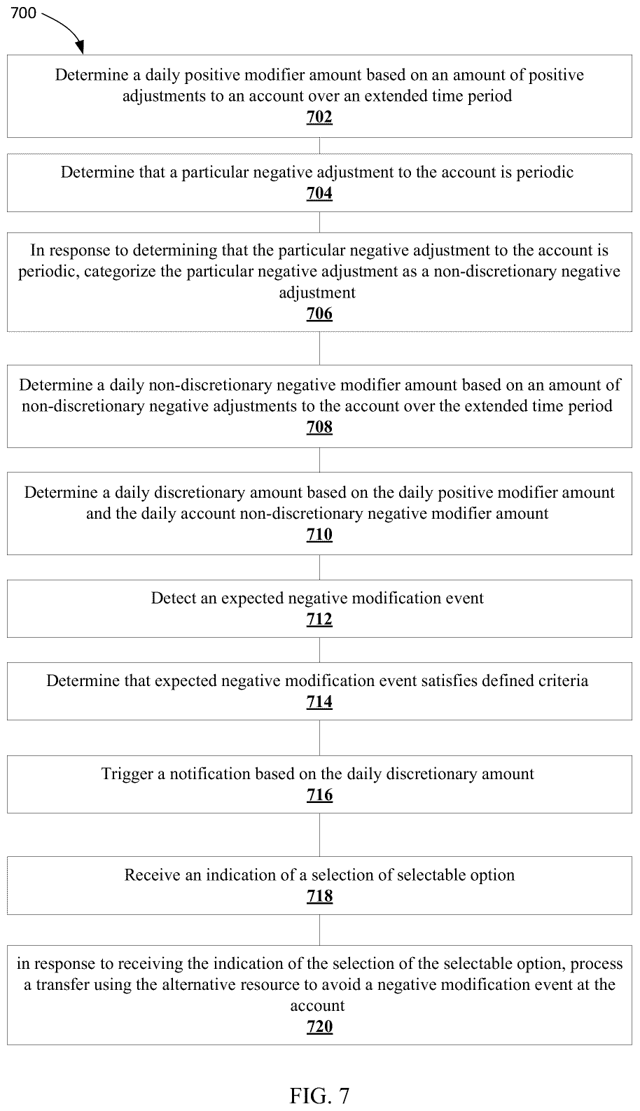

Reference will now be made to FIG. 7, which illustrates a flowchart of an example method 700. FIG. 7 shows operations performed by a computing system, such as the first server 130. For example, in at least some implementations, computer-executable instructions stored in memory associated with the computing system may configure the computing system to perform the operations of the method 700 or a portion thereof. By way of example, the computer-executable instructions may cause a processor associated with the computing system to perform the method 700 or a portion of the method 700.

The computing system performing the method 700 may cooperate with other computing systems using a communications module. The communications module may be or include a hardware communications module. In some implementations, the one or more of the other computer systems may perform one or more operations of the method 700 or may cooperate with the first server 130 in performing the method 700.

The method 700 may include one or more operations in common with the method 500 of FIG. 5 and the discussion of such operations will not be repeated in full for the sake of brevity and readability.

At an operation 702, the first server 130 may determine a daily positive modifier amount based on an amount of positive adjustments to an account over an extended time period. The operation 702 may be performed in the same or similar manner as the operation 502 of the method 500 described above.

In at least some implementations, the first server 130 may perform one or more operations in order to categorize adjustments to an account. The categorization may, in some implementations, include a discretionary category and a non-discretionary category. The categorization may be performed on historical data such as, for example, resource usage data for the account. By way of example, the resource usage data may be or include a transaction history. For example, past outgoing transfers may be categorized as either discretionary or non-discretionary, in at least some implementations.

In at least some implementations, the categorization of past transfers as discretionary and non-discretionary may be based on whether or not a particular negative adjustment is periodic. For example, at an operation 704, the first server 130 may determine whether a particular negative adjustment to the account is periodic. In the example illustrated in FIG. 7, the first server 130 determines that a particular negative adjustment to the account is periodic at the operation 704 and, in response to determining that the particular negative adjustment to the account is periodic, categorizing the particular negative adjustment as a non-discretionary negative adjustment at the operation 706.

If, instead, the first server 130 were to determine that the particular negative adjustment to the account is not periodic, the first server 130 may categorize the particular negative adjustment to the account as non-discretionary.

Determining whether a particular negative adjustment is periodic may involve determining whether the particular negative adjustment and other negative adjustments from the account to the same recipient or transferor are made at recurring intervals. For example, the first server 130 may determine whether such negative adjustments are made weekly, monthly, yearly, etc.

Other criteria may be used to categorize negative adjustments instead of or in addition to determining whether a negative adjustment is periodic. For example, a recipient or transferee identifier may be used to categorize negative adjustments as being either discretionary or non-discretionary. For example, the first server 130 may maintain or otherwise have access to a list of recipients/transferees that are considered discretionary and/or the first server 130 may maintain or otherwise have access to a list of recipients/transferees that are considered non-discretionary. Then, when performing the categorization, the first server 130 may compare a recipient/transferee for that transfer to the list and perform categorization based on the comparison.

Referring still to FIG. 7, at an operation 708 of the method 700, the first server 130 may determine a daily non-discretionary negative modifier amount based on an amount of non-discretionary negative adjustments to the account over the extended time period. The operation 708 may be performed in a manner that is the same or similar to the operation 504 of the method 500 as described above.

Next, at an operation 710, the first server 130 may determine a daily discretionary amount based on the daily positive modifier amount and the daily non-discretionary negative modifier amount. The operation 710 may be performed in the same or in a similar manner to the operation 506 of the method 500 of FIG. 5. In at least some implementations, the daily discretionary amount may be determined without reference to any past adjustments categorized as discretionary adjustments. That is, the daily discretionary amount may take into account past non-discretionary adjustments but not past discretionary adjustments. For example, the first server 130 may predict, project or otherwise determine expected non-discretionary adjustments for a time period based on past non-discretionary adjustments and, after doing so, may determine a daily discretionary amount.

In some implementations, a notification may be triggered by the first server 130 following the operation 710. The notification may be triggered in response to detecting the occurrence of a particular trigger condition. For example, in at least some implementations, the notification may be triggered in response to detecting an expected negative modification event. Such an event may be detected by the first server 130 at an operation 712 which may be performed in the same or in a similar manner to the operation 508 of the method 500 of FIG. 5.

In some implementations, the detection of the negative modification alone may cause the notification to be triggered. In other implementations, other criteria may be required to be satisfied before the notification will be triggered. For example, in the illustrated example of FIG. 7, the method 700 includes, at an operation 714, determining that the expected negative modification event satisfies defined criteria. The defined criteria may include a category of the expected negative modification event. For example, the criteria may be defined so that the notification is only triggered when the expected modification event is discretionary. The method 700 may include, for example, prior to triggering a notification, determining that the expected negative modification event is discretionary. The notification may only be triggered (at operation 716) responsive to determining that the modification event is discretionary. That is, the determination that the modification event is discretionary causes the notification to be triggered.

The determination of whether the expected modification event is discretionary may be performed in various ways. For example, the determination may be performed based on a transferee for the expected negative modification event. The transferee may be identified based on, for example, a geofence within which a client device associated with the account is located. For example, if the geofence is associated with a recipient that is included in a list of discretionary transferees, then it may be determined to be discretionary and, if it is not included in such a list or if it is included in a list of non-discretionary transferees, then it may be determined to be non-discretionary.

The determination of whether the expected negative modification event is non-discretionary may be performed in other ways. For example, the determination may be performed based on a transferee identifier included in a transfer that has been initiated. The transferee identifier may be compared with identifiers in a listing of discretionary and/or non-discretionary entities.

Other defined criteria may be used to cause the notification to be triggered. For example, in some implementations, the criteria may require an evaluation of the portion of the daily discretionary amount remaining for a current day. By way of example, the first server 130 may, at the operation 714, determine whether an amount of the expected negative modification event exceeds the portion of the daily discretionary amount remaining for the current day. If the first server 130 determines that the amount of the expected negative modification event exceeds the portion of the daily discretionary amount remaining for the current day, then the notification may be triggered at the operation 716. That is, the notification may be triggered responsive to determining that the amount of the expected negative modification event exceeds the portion of the daily discretionary amount remaining for the current day.

At the operation 714, the first server 130 may determine an amount of the expected negative modification event. This may be determined, for example, from metadata included in a transfer request which initiates the transfer. Such metadata may include a transfer amount and the amount of the expected negative modification event may be defined based on the amount of the transfer amount. For example, the expected negative modification event may be the transfer amount.

If the defined criteria is satisfied, then the notification may be triggered at the operation 716. The operation 716 may be performed in the same or in a similar way to the operation 510 of the method 500 of FIG. 5.

After the notification is triggered at a client device associated with the account, the first server 130 may receive (at an operation 716) a selection of a selectable option included in the notification. Put differently, the first server 130 may receive an indication that a selectable option included in the notification has been activated. Put differently, the first server 130 may receive, at an operation 718, an indication of a selection of the selectable option. Then, in response to receiving the indication of the selection of the selectable option, the first server 130 may perform an operation associated with the selectable option. For example, the first server 130 may, at an operation 720, process a transfer using an alternative resource to avoid a negative modification event at the account. Processing the transfer using an alternate resource may include sending a message to a point of sale terminal to indicate that the transfer has been processed and/or to indicate that the transfer has or should be processed using the alternate resource.

The selectable option may take other forms. For example, in one implementation, the selectable option may be an option to make a transfer between accounts.

Although FIG. 7 shows example operations of the method 700, in some implementations, the method 700 may include additional operations, fewer operations, different operations, or differently arranged operations than those depicted in FIG. 7. Additionally, or alternatively, two or more of the operations of the method 700 may be performed in parallel.

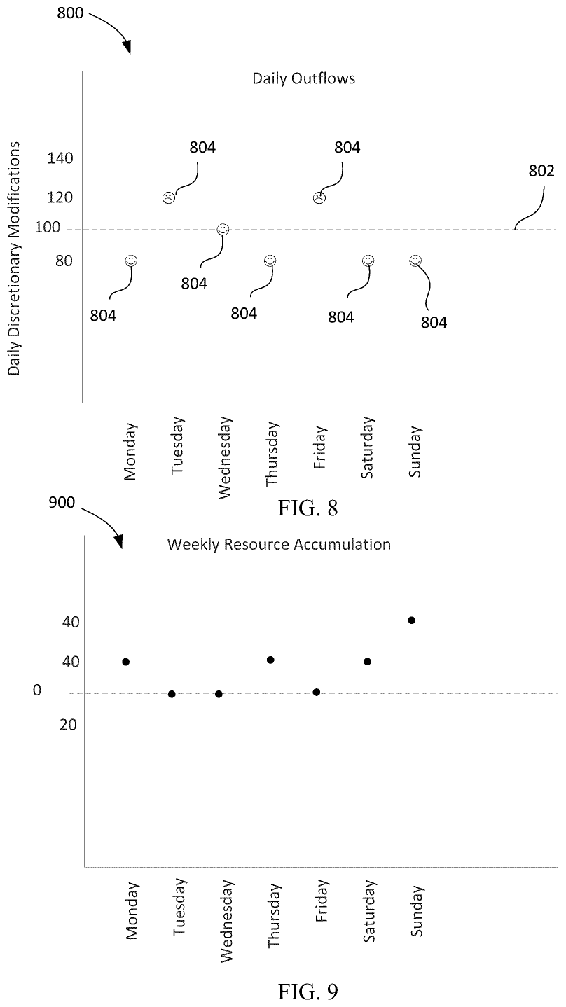

Notifications and other outputs or display screens that are based on a daily discretionary amount may take other forms. For example, referring to FIG. 8, an example graphical representation 800 is illustrated. The graphical representation 800 indicates recent daily discretionary modifications. The graphical representation 800 may indicate recent daily discretionary modifications relative to the daily discretionary amount. In the illustrated example, the daily discretionary amount is indicated with an indicator 802 which is a line. In the illustrated example, the indicator is at the S100 level since the daily discretionary amount is, in the example, determined to be $100.

The graphical representation may indicate how daily discretionary modifications on one or more particular days relate to the daily discretionary amount. For example, the graphical representation 800 may include indicators 804 which indicate whether the daily discretionary amount has been exceeded on days represented by the graphical representation. In the illustrated example, the indicators may be different for days in which the daily discretionary amount is exceeded than for days in which it is not exceeded. For example, in the illustrated example a happy face is used as the indicator 804 on days when the daily discretionary modifications did not exceed the daily discretionary amount and a sad face is used as the indicator 804 on days when the daily discretionary modifications exceeded the daily discretionary amount. Other forms of indicators may be used in other implementations.

The graphical representation 800 indicates the daily discretionary modifications on a per-day basis. The graphical representation 800 may represent such modifications on a per-day basis for a time period. The time period may be, for example, a week.

The graphical representation 800 may be displayed as part of the notifications triggered in the methods 500 and 700 described above. In other implementations, the graphical representation may be displayed as part of another notification. For example, the graphical representation 800 may be sent to a client device associated with the account upon expiration of a periodic timer. The periodic timer may be configured, for example, to send a weekly or monthly notification.

Accordingly, it may be that the methods 500 and 700 are modified to include operations of tracking daily discretionary amounts for an account on a per-day basis and generating a graphical representation 800 on a client device associated with the account.

The graphical representation may take other forms. For example, in one implementation, the graphical representation may be a calendar such as a monthly or weekly calendar and various days of the calendar may be populated with an indicator to indicate the daily discretionary modifications for that day and/or to indicate whether the daily discretionary modifications for that day exceed the daily discretionary amount. By way of example, it may be that color is used to highlight days on which the daily discretionary modifications exceed the daily discretionary amount and/or days on which the daily discretionary modifications do not exceed the daily discretionary amount. By way of example, red may be used for days where the daily discretionary modifications exceed the daily discretionary amount and green may be used for days on which the daily discretionary modifications do not exceed the daily discretionary amount.

Further, it may be that the graphical representation indicates an amount by which daily discretionary modifications exceed the daily discretionary amount on days where it exceeded the daily discretionary amount and/or to an amount by which the daily discretionary modifications fell short of the daily discretionary amount on days where it did not exceed the daily discretionary amount. By way of example, positive numerical indicators may indicate days when the daily discretionary modifications fell short of the daily discretionary amount and an amount at which the daily discretionary modifications fell short of the daily discretionary amount and negative numerical indicator may indicate days when the daily discretionary modifications exceeds the daily discretionary amount on days where it exceeded the daily discretionary amount. The positive indication may signify resources saved on a particular day by not exceeding the discretionary amount for that day.

Referring now to FIG. 9, a further example graphical representation 900 is illustrated. The graphical representation 900 of FIG. 9 is configured to indicate resource accumulation over a time period, such as a week or month. The graphical representation 900 of FIG. 9 indicates how resources accumulate over time based on daily discretionary modifications relative to the daily discretionary amount. The graphical representation 900 of FIG. 9 uses the same data set as the graphical representation 800 of FIG. 8 so that the graphical representation 900 of FIG. 9 can be better understood. As shown in FIG. 8, on Monday the daily discretionary modifications fell short of the daily discretionary amount by 20 units and so in FIG. 9, on Monday, 20 units of resource accumulation is represented. The units may be units of currency, for example. Then, as illustrated in FIG. 8, on Tuesday the daily discretionary amount is exceeded by 20 units. This represents a resource depletion of 20 units and so the total accumulation from the previous day (20 units in the example) is adjusted to reflect the depletion. Consequently, in the illustrated example, Tuesday shows an accumulation of 0 units. For each day, the total accumulation from the previous day is adjusted to reflect any resource accumulation or depletion attributed to the current day.

The graphical representation 900 of FIG. 9 may be displayed as part of the notifications triggered in the methods 500 and 700 described above. In other implementations, the graphical representation may be displayed as part of another notification. For example, the graphical representation 900 may be sent to a client device associated with the account upon expiration of a periodic timer. The periodic timer may be configured, for example, to send a weekly or monthly notification.

Accordingly, it may be that the methods 500 and 700 are modified to include operations of tracking daily discretionary amounts for an account on a per-day basis and generating a graphical representation 900 on a client device associated with the account.

In some implementations, the graphical representations 800, 900 of FIGS. 8 and 9 may be displayed on a common display and/or concurrently.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification.

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computing system comprising:
a processor;
a communications module coupled to the processor;
a memory coupled to the processor, the memory storing instructions that, when executed, configure the computing system to:
determine a daily positive modifier amount based on an amount of positive adjustments to an account over an extended time period;
determine a daily non-discretionary negative modifier amount based on an amount of non-discretionary negative adjustments to the account over the extended time period;
determine a daily discretionary amount based on the daily positive modifier amount and the daily non-discretionary negative modifier amount;
detect an expected negative modification event; and
in response to detecting the expected negative modification event, trigger a notification based on the daily discretionary amount.

2. The computing system of claim 1, wherein the expected negative modification event is detected based on a location associated with a client device on which the notification is triggered.

3. The computing system of claim 2, wherein the expected negative modification event is detected by determining that the client device is within a particular geofence.

4. The computing system of claim 3, wherein the particular geofence is a geofence associated with discretionary modifications.

5. The computing system of claim 1, wherein detecting the expected negative modification event includes detecting an initiation of a transfer.

6. The computing system of claim 5, wherein the transfer is initiated at a point-of-sale terminal.

7. The computing system of claim 1, wherein the notification includes a selectable option to utilize an alternate resource for the expected negative modification event.

8. The computing system of claim 7, wherein the instructions further configure the computing system to:
receive an indication of a selection of the selectable option;
in response to receiving the indication of the selection of the selectable option, process a transfer using the alternate resource to avoid a negative modification event at the account.

9. The computing system of claim 1, wherein the instructions further configure the computing system to:
determine that a particular negative adjustment to the account is periodic; and
in response to determining that the particular negative adjustment to the account is periodic, categorize the particular negative adjustment as a non-discretionary negative adjustment.

10. The computing system of claim 1, wherein the daily discretionary amount is determined without reference to any past adjustments categorized as discretionary adjustments.

11. The computing system of claim 1, wherein the instructions further configure the computing system to:
prior to triggering the notification, determine that the expected negative modification event is discretionary and wherein the notification is triggered responsive to determining that the expected negative modification event is discretionary.

12. The computing system of claim 1, wherein the notification indicates a portion of the daily discretionary amount remaining for a current day.

13. The computing system of claim 12, wherein the instructions further configure the computing system to:
determine that an amount of the expected negative modification event exceeds the portion of the daily discretionary amount remaining for the current day, and
wherein the notification is triggered responsive to determining that the amount of the expected negative modification event exceeds the portion of the daily discretionary amount remaining for the current day.

14. The computing system of claim 1, wherein the notification includes a graphical representation indicating recent daily discretionary modifications relative to the daily discretionary amount.

15. A method comprising:
determining a daily positive modifier amount based on an amount of positive adjustments to an account over an extended time period;
determining a daily non-discretionary negative modifier amount based on an amount of non-discretionary negative adjustments to the account over the extended time period;
determining a daily discretionary amount based on the daily positive modifier amount and the daily non-discretionary negative modifier amount;
detecting an expected negative modification event; and
in response to detecting the expected negative modification event, triggering a notification based on the daily discretionary amount.

16. The method of claim 15, wherein the expected negative modification event is detected based on a location associated with a client device on which the notification is triggered.

17. The method of claim 16, wherein the expected negative modification event is detected by determining that the client device is within a particular geofence.

18. The method of claim 17, wherein the particular geofence is a geofence associated with discretionary modifications.

19. The method of claim 15, wherein detecting the expected negative modification event includes detecting an initiation of a transfer.

20. A non-transitory computer-readable medium storing a set of instructions, the set of instructions comprising:
one or more instructions that, when executed by one or more processors of a device, cause the device to:
determine a daily positive modifier amount based on an amount of positive adjustments to an account over an extended time period;
determine a daily non-discretionary negative modifier amount based on an amount of non-discretionary negative adjustments to the account over the extended time period;
determine a daily discretionary amount based on the daily positive modifier amount and the daily non-discretionary negative modifier amount;
detect an expected negative modification event; and
in response to detecting the expected negative modification event, trigger a notification based on the daily discretionary amount.
